(19) United States
(12) Patent Application Publication
(10) Pub. No.: US 2006/0197469 A1
(43) Pub. Date: Sep. 7, 2006

(54) Light emitting diode (LED) driver

(75) Inventor: Nam-in Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/336,986

(22) Filed: Jan. 23, 2006

(30) Foreign Application Priority Data
Feb. 26, 2005 (KR) 10-2005-0016208

(51) Int. Cl. H05B 41/36

(52) U.S. Cl. 315/291

(57) ABSTRACT

An LED driver is provided for driving a plurality of light emitting diodes (LEDs), having a current controller to control a power supply of a predetermined power source unit to establish a current in the plurality of LEDs at a predetermined target current value and which sequentially changes corresponding to the respective LEDs, a plurality of divergence switches to allow flow or interrupt flow of the current with respect to each of the plurality of LEDs, and a divergence switch controller to sequentially open and close the plurality of divergence switches corresponding to changes of the target current value to make one of the plurality of divergence switches turn on before another one of the plurality of divergence switches is turned off. Thus, the LED driver has high light efficiency and excellent circuit stability without electromagnetic interference (EMI).

### CROSS-REFERENCE TO RELATED APPLICATIONS

This application claims the benefit under 35 U.S.C. §119(a) of Korean Patent Application No. 10-2005-0016208, filed in the Korean Intellectual Property Office on Feb. 26, 2005, the entire disclosure of which is incorporated herein by reference.

### BACKGROUND OF THE INVENTION

1. Field of the Invention

The present invention relates to an LED driver. More particularly, the present invention relates to an LED driver which drives light emitting diodes with high light efficiency and improved circuit stability.

2. Description of the Related Art

Light emitting diodes (LEDs) are typically used as a light source of a liquid crystal display (LCD) apparatus, as well as a digital micromirror device (DMD) display apparatus such as a digital light processing (DLP) projection TV, projector, and the like, that use a digital micromirror device (DMD).

FIG. 1 illustrates a DMD display apparatus which employs LEDs as the light source. The DMD display apparatus employs a plurality of LED modules 210 corresponding to respective colors of red (R), green (G) and blue (B).

The LED modules 210 are driven by an LED driver 200, and emit light signals of R, G and B to sequentially project them to a DMD module 230 through a lens 220. Hundreds of thousands, or up to millions of mirrors 240 are integrated in the DMD module 230 by a microelectro-mechanical systems (MEMS) process, and independently turn on and off. Accordingly, R, G and B color signals projected to the DMD module 230 display a predetermined picture on a screen 250.

The DMD display apparatus using the LEDs as the light source has a high usability level of the light source as compared with a wave form of a conventional display apparatus using a discharging lamp as the light source. Thus, the DMD display apparatus has high light efficiency, the LEDs have a longer life span than the discharging lamp, and a mechanical apparatus such as a color wheel is not required.

The LED driver 200 for driving the LED modules 210 may comprise a circuit configuration as shown in FIG. 2. The LED driver 200 in FIG. 2 may be referred to as a switch mode driving circuit. The LED driver 200 in FIG. 2 may comprise a current detector 271, an error amplifier 272, a pulse width modulation (PWM) modulator 274, a gate circuit 276, a switch 278, an inductor 280, a first diode 282, a second diode 284 and a switch block 286.

The LED driver 200 detects the current flowing in the LED modules 210 through the current detector 271, compares a voltage corresponding to the detected current and a target voltage Vref through the error amplifier 272, and outputs a voltage difference signal between the two voltages. The PWM modulator 274 compares an output of the error amplifier 272 and a predetermined triangular wave, and generates a PWM signal. The gate circuit 276 drives the switch 278, which is comprised of a metal-oxide semiconductor field effect transistor (MOSFET), using the PWM signal. The inductor 280 integrates a square wave pulse output of the switch 278 and allows the LED modules 210 to be supplied with a direct current having a switching ripple.

As the amount of light for each of the R, G and B colors is different in white light, a value of a current Io flowing in the LED modules 210 should preferably be different for each of the R, G and B colors, and it may be adjusted through the reference voltage Vref. The switch block 286 comprises a divergence switch which is connected to the LED module 210 corresponding to each of the R, G and B colors, and establishes the current Io flow in the LED module 210 by synchronizing with changes of the reference voltage Vref.

The LED module 210, which is driven by the LED driver 200, is comprised of a single module connecting dozens of LEDs in series and/or parallel corresponding to each of the R, G and B colors, and a current of more than 20 A and a voltage of more than 20V are required to drive the LED module 210. Also, a ripple of the current Io is preferably reduced as much as possible for equalizing the characteristic of the picture quality. The switching and the transient phenomenon speeds should preferably be increased as much as possible for providing high light efficiency when sequentially driving the LED module 210 corresponding to each of the R, G and B colors.

The driving circuit of the switch mode in FIG. 2 is preferably fast enough to ensure high efficiency with respect to high power. However, the inductor 280 should preferably have a large inductance or a switching frequency should be drastically raised to reduce the ripple. However, if the inductance is raised, the transient phenomenon becomes slow, thereby lowering the light efficiency.

Further, by driving the LED driver 200 with a discontinuous current mode (DCM), as shown by a pair of wave forms in an upper part in FIG. 3, a dead zone is lengthened in which the DMD cannot operate due to the slow transient phenomenon of the inductor having such a large inductance, thereby lowering the light efficiency. FIG. 3 illustrates wave forms of a gate voltage and an LED current of the LED driver in FIG. 1.

As shown in a pair of wave forms at a lower part in FIG. 3, the flow of the current Io is changed into a continuous current mode (CCM) and the light efficiency is increased slightly if the dead zone is reduced while changing the divergence switch in the LED driver 200. However, a reverse recovery current of the second diode 284 generated while changing the divergence switch may adversely affect stability of electromagnetic interference (EMI) and stability of the circuit.

For example, the reverse recovery current generated while a current of about 20 A flows in the LED module 210 may be up to or more than 100 A. As the reverse recovery current flows through the LED module 210, it may accelerate deterioration of the LEDs. Further, the DMD module is turned off until the reverse recovery current disappears and the circuit is stabilized, thereby lowering the light efficiency.

Accordingly, a need exists for a system and method for providing an LED driver which has high light efficiency and excellent circuit stability

### SUMMARY OF THE INVENTION

Accordingly, it is an aspect of the present invention to substantially solve the above and other problems, and provide an LED driver which has high light efficiency and excellent circuit stability without electromagnetic interference (EMI).

Additional aspects and advantages of the present invention will be set forth in part in the description which follows and, in part, will be obvious from the description, or may be learned by practice of the invention.

The foregoing and other aspects of the present invention are substantially achieved by providing an LED driver for driving a plurality of light emitting diodes (LEDs), comprising a current controller to control a power supply of a predetermined power source unit to establish a current flow in the plurality of LEDs at a predetermined target current value which sequentially changes corresponding to the respective LEDs, a plurality of divergence switches to allow current flow or to interrupt the current flow with respect to each of the plurality of LEDs, and a divergence switch controller to sequentially open and close the plurality of divergence switches corresponding to changes of the target current value to make one of the plurality of divergence switches turn on before another one of the plurality of divergence switches is turned off.

According to an aspect of the present invention, the current controller comprises a switch to supply or cut off power of the power source unit, a current detector to detect the current flowing in the plurality of LEDs, an error amplifier to compare the current detected by the current detector and the target current value and output a signal corresponding to a difference between the detected current and the target current value, a pulse width modulator to generate and output a pulse width modulation signal corresponding to an output signal of the error amplifier, a switch driver to drive the switch by outputting a signal for opening and closing the switch according to the pulse width modulation signal, an inductor connected in series between the power source unit and the plurality of LEDs to integrate a square wave current that is provided by supplying and cutting-off power from the power source unit, and a diode to freewheel the current flowing in the inductor if the switch is turned off.

According to another aspect of the present invention, the divergence switch controller comprises a counter to count a clock signal having a predetermined frequency and to sequentially output a signal respectively corresponding to the plurality of divergence switches, a decoder to decode the output signal of the counter and output a pulse signal having a logical high state in sequence, a delayer to delay a point of time where the logical state of the respective pulse signals of the decoder is changed from a high state to a low state, to a point of time after the logical state of the pulse signal of a next divergence switch is changed from a low state to a high state, and a divergence switch driver to turn on or off the corresponding divergence switches as the respective output signals of the delayer are changed to the logical high state or the logical low state.

According to another aspect of the present invention, the LED driver further comprises a microcomputer to output data of the target current value corresponding to a signal in the logical high state with respect to the respective pulse signals of the decoder, and a DA (digital-to-analog) converter to convert the data of the target current value output from the microcomputer into an analog signal to supply it to the current controller.

### BRIEF DESCRIPTION OF THE DRAWINGS

The above and other aspects and advantages of the present invention will become apparent and more readily appreciated from the following description of the embodiments, taken in conjunction with the accompanying drawings, of which:

FIG. 1 illustrates a configuration of a digital micromirror device (DMD) display apparatus using a conventional LED driver;

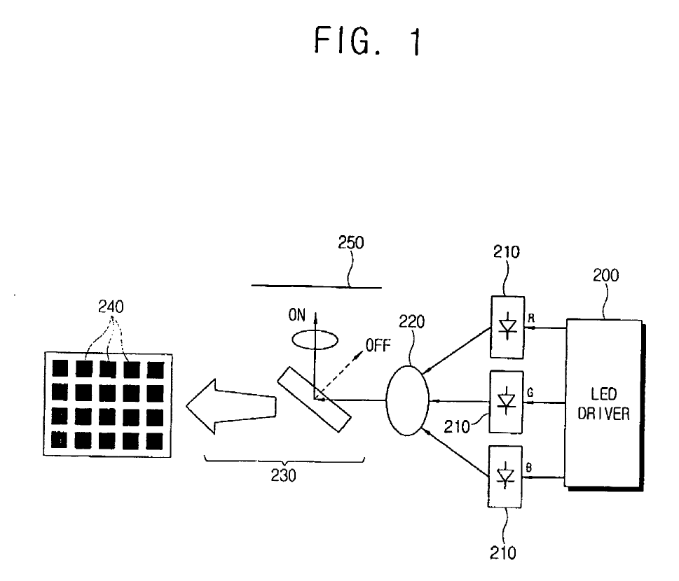

FIG. 2 illustrates a circuit configuration of the LED driver in FIG. 1;

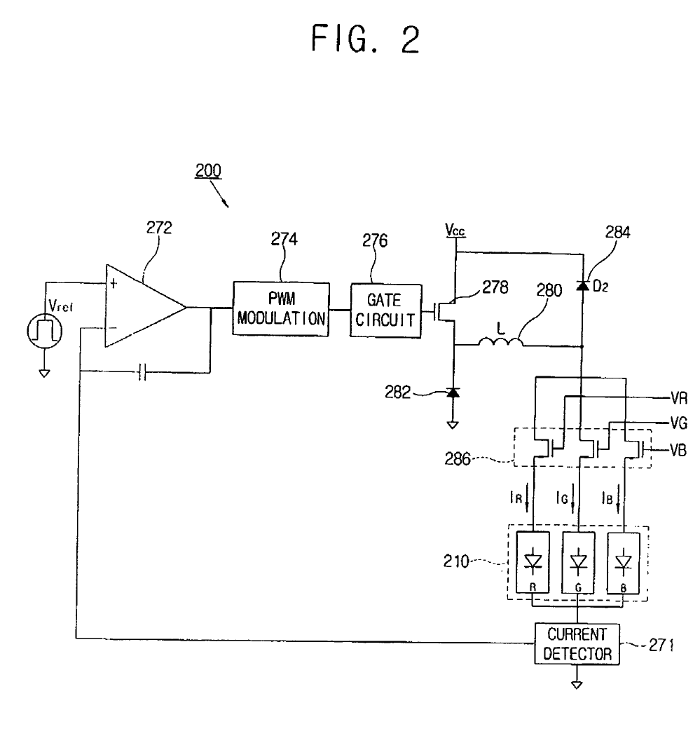

FIG. 3 illustrates wave forms of a gate voltage and an LED current of the LED driver in FIG. 1;

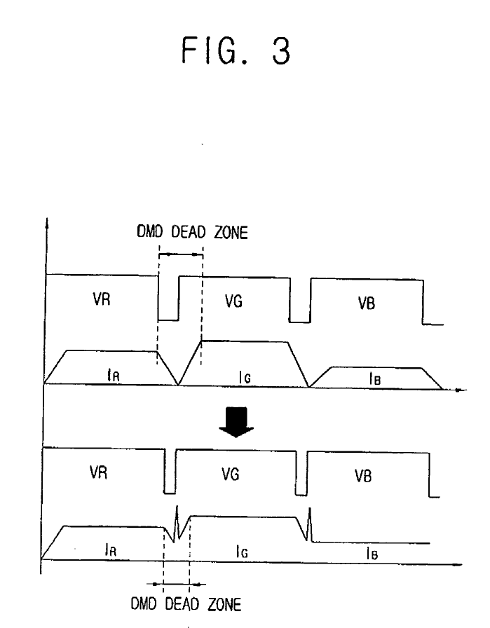

FIG. 4 illustrates a circuit configuration of an LED driver according to an embodiment of the present invention;

FIG. 5 illustrates wave forms of a target voltage, a gate voltage and an LED current of the LED driver in FIG. 4;

FIG. 6 illustrates an internal configuration of an exemplary divergence switch controller of the LED driver in FIG. 4; and

FIG. 7 illustrates wave forms of respective voltages and currents of the divergence switch controller in FIG. 6.

Throughout the drawings, like reference numerals will be understood to refer to like parts, components and structures.

### DETAILED DESCRIPTION OF THE EXEMPLARY EMBODIMENTS

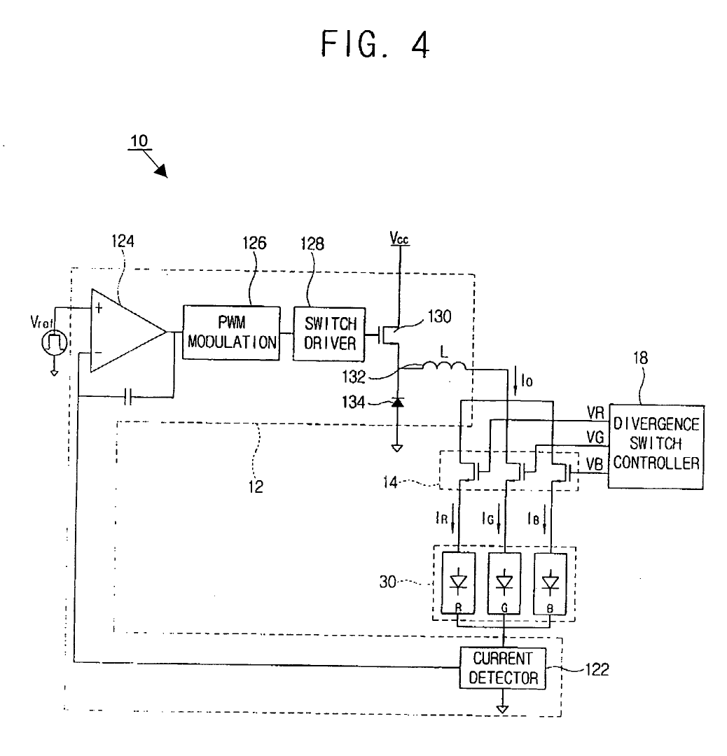

Reference will now be made in detail to embodiments of the present invention, examples of which are illustrated in the accompanying drawings, wherein like reference numerals refer to like elements throughout. The embodiments are described below in order to explain the present invention by referring to the figures. FIG. 4 illustrates a configuration of an LED driver 10 according to an exemplary embodiment of the present invention.

The LED driver 10 of the embodiment drives a plurality of LEDs 30 which are used as a light source of a digital micromirror device (DMD) display apparatus, such as a digital light processing (DLP) projection TV, projector, and the like, using the DMD, and an LCD back light.

As shown in FIG. 4, the LED driver 10 comprises a current controller 12, a plurality of divergence switches 14, and a divergence switch controller 18. The plurality of divergence switches 14 of the embodiment are disposed between the current controller 12 and an anode of the plurality of LEDs 30. A cathode of the plurality of LEDs 30 is connected to a current detector 122 of the current controller 12. Each of the plurality of LEDs 30 is provided as a module comprised of a plurality of LEDs corresponding to the respective R, G and B colors, but is not limited thereto.

The current controller 12 of the embodiment establishes a current Io flowing in the plurality of LEDs 30 at a predetermined target current value. That is, the current controller 12 of the embodiment controls a power Vcc from a predetermined power source unit to be supplied or cut off with respect to the LEDs 30. Here, the target current value refers to a current size to be applied to the plurality of LEDs 30. The target current value can be preset corresponding to the LEDs 30, and is provided such that it sequentially changes in the order of R, G and B colors with a predetermined interval, but is not limited thereto.

As shown in FIG. 4, the current controller 12 comprises the current detector 122, an error amplifier 124, a pulse width modulator 126, a switch 130, a switch driver 128, an inductor 132 and a diode 134.

The current detector 122 detects the current Io flowing in the plurality of LEDs 30. The current detector 122 may be comprised of a resistor having a predetermined resistance value wherein a first end thereof is connected with the plurality of LEDs 30 and a second end thereof is connected to ground. The current Io flowing in the plurality of LEDs 30 may be calculated using a voltage and resistance value thereof, and provide a voltage corresponding to the current Io.

A first end of the inductor 132 is connected to the switch 130 and a cathode of the diode 134, and a second end thereof is connected to the plurality of LEDs 30. The current flowing in the inductor 132 becomes the current Io flowing in the plurality of LEDs 30. An anode of the diode 134 is connected to ground.

The switch 130 of embodiments of the present invention is comprised of a metal-oxide semiconductor field effect transistor (MOSFET), but is not limited thereto. A gate of the switch 130 is connected to an output terminal of the switch driver 128, and a drain of the switch 130 is connected to a power source unit (not shown) and receives a power voltage Vcc. Also, a source of the switch 130 is connected to the first end of the inductor 132 and the cathode of the diode 134.

The switch 130 is turned on and off according to the logical state of a gate voltage input to the gate to perform switching operations. If the switch 130 is turned on, the current flows between the drain and the source, and the power voltage Vcc is applied to the inductor 132. As the turn-on time passes, the current flowing in the inductor 132 reaches a predetermined level, thereby increasing the current Io. If the switch 130 is turned off, the current flow between the drain and the source is cut off and the current in the inductor 132 flows through the LEDs 30 and the diode 134 to form a loop. At this time, the current Io decreases as the power supply is cut off.

The error amplifier 124 receives the voltage corresponding to the current Io flowing in the plurality of LEDs 30 from the current detector 122 at an inverting input terminal, and the predetermined target voltage Vref corresponding to the target current value at a non-inverting input terminal. The error amplifier 124 amplifies a voltage difference between the voltage corresponding to the current Io flowing in the LEDs 30 and the target voltage Vref to output the difference as an output signal.

The pulse width modulator 126 generates and outputs a pulse width modulation signal corresponding to the output signal of the error amplifier 124. The switch driver 128 outputs a signal to open and close the switch 130 according to the pulse width modulation signal output from the pulse width modulator 126. That is, the current controller 12 of embodiments of the present invention detects the current Io flowing in the LEDs 30 and switch-controls the applied Vcc until the current Io reaches the predetermined target value.

The plurality of divergence switches 14 are connected to the anode of the LEDs 30 corresponding to each of the LEDs 30. The divergence switches 14 are turned on and off to supply and cut off the current Io corresponding to each of the LEDs 30. The plurality of divergence switches 14 of embodiments of the present invention are comprised of a metal-oxide semiconductor field effect transistor (MOSFET), respectively, but are not limited thereto.

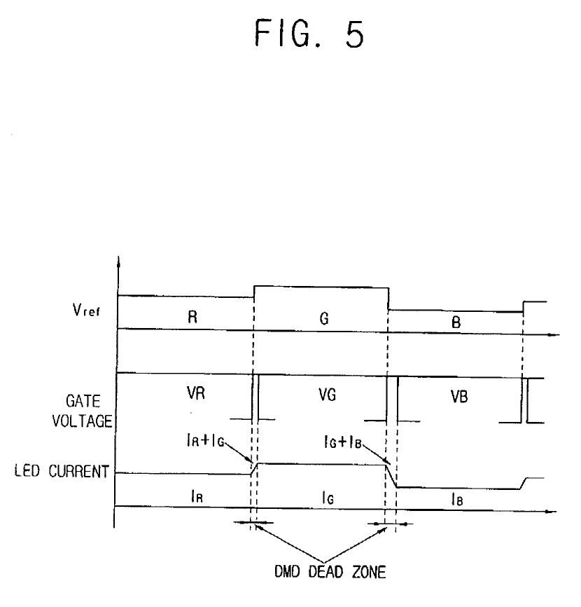

The divergence switch controller 18 sequentially opens and closes the plurality of divergence switches 14 corresponding to changes of the target current value. In embodiments of the present invention, the divergence switch controller 18 controls one of the divergence switches 14 to be turned on before another one of them is turned off. FIG. 5 illustrates exemplary wave forms of the target voltage Vref for the control of the divergence switch controller 18, and gate voltages VR, VG and VB supplied to the gates of the respective divergence switches 14.

The divergence switch controller 18 controls the divergence switches 14 such that there is an interval in which the switches are superposed upon each other and turned on, and are not simultaneously turned off if the switching operation is changed from one of the switches 14 to another, thereby shortening transient response time of the current Io flowing in the LEDs 30 and preventing a reverse recovery current from being generated thanks to omission of a freewheeling diode for consuming the current of the inductor 132.

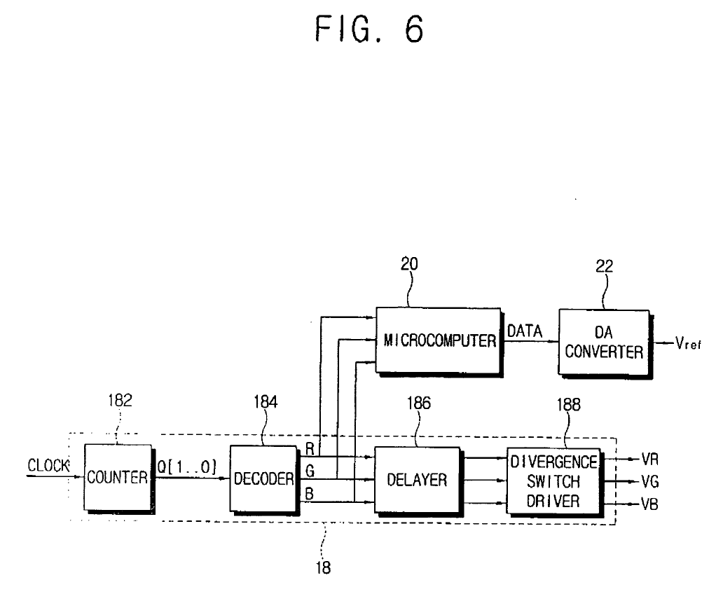

As shown in FIG. 6, the divergence switch controller 18 comprises a counter 182, a decoder 184, a delayer 186 and a divergence switch driver 188.

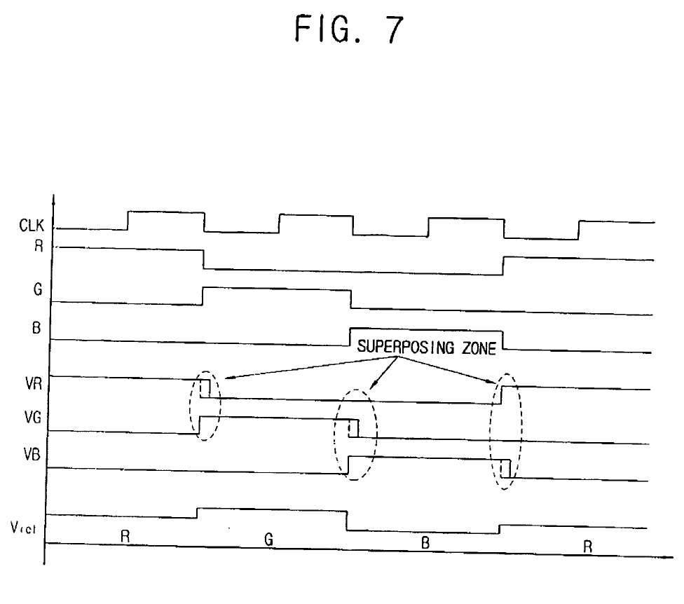

The counter 182 receives a clock signal (referred to as “CLK” in FIG. 7) having a predetermined frequency and counts the clock signal to sequentially output a signal Q[1 . . . 0], respectively, corresponding to each switch of the divergence switch 14 of the R, G and B colors. That is, the counter 182 is a ternary counter which counts the clock signal, and outputs a two-bit output signal (0→01→10→00 . . . ) for three conditions corresponding to the respective R, G and B colors. The decoder 184 decodes the output signal of the counter 182 and outputs a parallel pulse signal (referred to a “R”, “G” and “B” in FIG. 7) having a logical high state in sequence. That is, the decoder 184 receives the two-bit output signal (00→01→10→00 . . . ) indicating the three conditions corresponding to the respective R, G and B colors, and decodes the signal to generate three pulse signals having the logical high state through three parallel output ports in sequence.

For example, if the output signal of the counter 182 is “00”, the decoder 184 of the embodiment makes a signal corresponding to “R” be in the logical high state and signals corresponding to “G” and “B” be in the logical low state. If the output signal of the counter 182 is “01”, the decoder 184 makes the signal corresponding to “G” be in the logical high state, and the signals corresponding to “B” and “R” be in the logical low state. If the output signal of the counter 182 is “10”, the decoder 184 makes the signal corresponding to “B” be in the logical high state, and the signals corresponding to “R” and “G” be in the logical low state. The change of the logical state of the pulse signal corresponding to pairs among R, G and B colors occurs simultaneously at a predetermined interval as described in greater detail below.

The delayer 186 receives the respective pulse signals of the decoder 184. If the logical state of the pulse signal corresponding to a pair among the R, G and B colors is changed, the delayer 186 delays a point of time where the logical state of the pulse signal is changed from the high state to the low state, such that the change occurs after a point of time where the logical state of the pulse signal is changed from the low state to the high state. That is, the delayer 186 delays the point of time where the logical state of the pulse signal is changed, which is already in the logical high state, for a predetermined time, thereby superposing the pulse signal to be changed to the high state upon the pulse signal currently in the high state for a predetermined time.

For example, if “R” is in the logical high state, and “G” and “B” are in the low state for each pulse signal of the decoder 184, the delayer 186 delays the point of time where the logical state of the pulse signal corresponding to “R” is changed to the low state for the predetermined time, changing the logical state of the pulse signal corresponding to “G” from the low state to the high state, and then changing the logical state of the pulse signal corresponding to “R” to the low state. Also, if the pulse signal corresponding to “G” or “B” is in the logical high state and the pulse signals corresponding to “B” and “R”, or “R” and “G” are in the logical low state, the delayer 186 delays the point of time where the logical state of the pulse signal corresponding to “G” or “B” is changed to the low state for the predetermined time.

It is preferred but not necessary, that the delaying time of changing the logical state of the pulse signal corresponding to “R”, “G” or “B” is shorter than a change interval of the respective pulse signals. The delayer 186 of embodiments of the present invention may be comprised of a passive circuit such as a resistor and a condenser, which are connected in series and/or in parallel, but is not limited thereto.

The divergence switch driver 188 outputs gate signals (referred to as “VR”, “VG” and “VB” in FIG. 7) to the gates of the divergence switches 14 which turn on and off the corresponding divergence switches 14 as the respective output signals of the delayer 186 are changed to the logical high state or the logical low state. As shown in FIG. 7, the plurality of divergence switches 14 have an interval in which the divergence switches 14 are superposed upon each other, that is, turned on by turning on one of the divergence switches 14 before turning off another one of the divergence switches 14. This results since the point of time where the logical state of the respective gate signals VR, VG or VB is changed from the high state to the low state is later than the time where the logical state of next gate signal is changed from the low state to the high state.

The LED driver 10 of embodiments of the present invention may further comprise a microcomputer 20 to output data which indicates the target current value corresponding to the pulse signal in the logical high state with respect to the respective pulse signals of the decoder 184. The microcomputer 20 sets up data indicating target current values IR, IG and IB of the plurality of LEDs 30 in advance corresponding to values of the R, G and B colors of an image signal to be output. Also, the microcomputer 20 receives the three pulse signals of the decoder 184 corresponding to the R, G, and B colors to check the logical state of the respective pulse signals and output data indicating the target current values IR, IG or IB corresponding to the color of the pulse signal in the logical high state. The microcomputer 20 of embodiments of the present invention further output data of the target voltage Vref corresponding to the target current values IR, IG or IB. The microcomputer 20 of embodiments of the present invention may be comprised of a general microprocessor, and comprise a memory such as a ROM and a RAM as necessary.

Also, the LED driver 10 of embodiments of the present invention may further comprise a DA (digital-to-analog) converter 22 which converts the data indicating the target current values IR, IG and IB output from the microcomputer 20 into an analog signal, and provides them to the current controller 12.

Although a number of exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. An LED driver for driving a plurality of light emitting diodes (LEDs), comprising:
a current controller for controlling a power supply to establish a current flow in the plurality of LEDs at a predetermined target current value which sequentially changes corresponding to the respective LEDs;
a plurality of divergence switches for switching the current with respect to each of the plurality of LEDs; and
a divergence switch controller for sequentially opening and closing the plurality of divergence switches corresponding to changes of the target current value such that one of the plurality of divergence switches is turned on before another one of the plurality of divergence switches is turned off.

2. The LED driver according to claim 1, wherein the current controller comprises:
a switch for supplying or cutting off power of the power supply;
a current detector for detecting the current flowing in the plurality of LEDs;
an error amplifier for comparing the current detected by the current detector and the target current value, and outputting a signal corresponding to a difference between the detected current and the target current value;
a pulse width modulator for generating a pulse width modulation signal corresponding to an output signal of the error amplifier;
a switch driver for driving the switch by outputting a signal for opening and closing the switch according to the pulse width modulation signal;
an inductor in series between the power source unit and the plurality of LEDs for integrating a square wave current provided by supplying and cutting-off power from the power source unit; and
a diode for freewheeling the current flowing in the inductor when the switch is turned off.

3. The LED driver according to claim 1, wherein the divergence switch controller comprises:
a counter for counting a clock signal having a predetermined frequency and sequentially outputting a signal corresponding to the plurality of divergence switches, respectively;
a decoder for decoding the output signal of the counter and outputting a pulse signal having a logical high state in sequence, wherein the pulse signal is output in parallel for each color of the LEDs;
a delayer for delaying a point of time where the logical state of the respective pulse signals of the decoder is changed from a high state to a low state, such that the change from a high state to a low state occurs after a point of time where the logical state of the pulse signal of a next divergence switch is changed from a low state to a high state; and
a divergence switch driver for turning on or off the corresponding divergence switches as the respective output signals of the delayer are changed to the logical high state or the logical low state, respectively.

4. The LED driver according to claim 3, further comprising:
a microcomputer for outputting data of the target current value corresponding to a signal in the logical high state with respect to the respective pulse signals of the decoder; and
a DA (digital-to-analog) converter for converting the data of the target current value output from the microcomputer into an analog signal to supply it to the current controller.

5. An method for driving a plurality of light emitting diodes (LEDs), comprising the steps of:
controlling a power supply to establish a current flow in the plurality of LEDs at a predetermined target current value which sequentially changes corresponding to the respective LEDs;
controlling a plurality of divergence switches for switching the current with respect to each of the plurality of LEDs; and
sequentially opening and closing the plurality of divergence switches corresponding to changes of the target current value such that one of the plurality of divergence switches is turned on before another one of the plurality of divergence switches is turned off.

6. The method according to claim 5, further comprising the steps of:
detecting the current flowing in the plurality of LEDs;
comparing the current detected and the target current value, and outputting a signal corresponding to a difference between the detected current and the target current value for generating a pulse width modulation signal; and
outputting a signal for opening and closing a power supply switch according to the pulse width modulation signal.

7. The method according to claim 5, further comprising the steps of:
counting a clock signal having a predetermined frequency and sequentially outputting a signal corresponding to a plurality of divergence switches, respectively;
decoding the sequentially output signal and outputting a pulse signal having a logical high state in sequence, wherein the pulse signal is output in parallel for each color of the LEDs;
delaying a point of time where the logical state of the respective pulse signals is changed from a high state to a low state, such that the change from a high state to a low state occurs after a point of time where the logical state of the pulse signal of a next divergence switch is changed from a low state to a high state; and
turning on or off the corresponding divergence switches as the respective output signals are changed to the logical high state or the logical low state.

8. The method according to claim 7, further comprising the steps of:
outputting data of the target current value corresponding to a signal in the logical high state with respect to the respective pulse signals; and
converting the data of the target current value output into an analog signal.
